(19) United States
(12) Patent Application Publication
(10) Pub. No.: US 2003/0163780 A1
(43) Pub. Date: Aug. 28, 2003

(54) Enhancing management of a distributed computer system

(76) Inventor: Marc Kossa, Vaulnaveys le bas (FR)

Correspondence Address: PARK, VAUGHAN & FLEMING LLP, 508 SECOND STREET, SUITE 201, DAVIS, CA, 95616, US

(21) Appl. No.: 10/354,335

(22) Filed: Jan. 29, 2003

(30) Foreign Application Priority Data
Feb. 18, 2002 (FR) 0202025

(51) Int. Cl. G06F 15/00

(52) U.S. Cl. 715/500

(57) ABSTRACT

One embodiment of the present invention provides a computer system for use in relation with a group of nodes. The computer system includes a manager adapted for communication with a link to a network existing between the nodes, so as to access node status data and node management functions. It also includes a graphical user interface being adapted to cooperate with the manager for graphically displaying representations of nodes of the group of nodes from node status data, and representations of node management functions. The manager is also capable of responding to a user action on a representation of said node management function, for causing execution of that node management function.

### RELATED APPLICATION

This application hereby claims priority under 35 U.S.C §119 to French patent application No. 0202025, filed Feb. 18, 2002, entitled “Enhancing Management of a Distributed Computer System,” Attorney Docket No. SUN Aff. 36.

### RELATED ART

The invention relates to a distributed computer system, for example a distributed computer system providing an extensible distributed software execution environment.

Such an environment is a software platform, which may be intended for management and control applications for network components. Such a platform is composed of a group of cooperating nodes, also called a cluster, some nodes having hard disk and designated as diskfull and other nodes having no hard disk and designated as diskless. Such cluster has to be managed. To enable this management, a user has to know, for example, the state of this cluster at any time.

There exists a user interface of “log” type enabling a user to know the port on which the node is, the concentrator to which the node is connected, and to follow the command lines which are running on a node. However, it is not easy for a user to know if the cluster is in a coherent state. The user has to establish a connection with successive nodes, to execute a series of instructions on each node, to store results of instructions and to exploit said results. This is a long and fastidious work, and results are not easy to interpret.

The present invention provides advances towards high availability.

In one aspect, this invention concerns a computer system for use in relation with a group of nodes, comprising:

a manager adapted for communication with a link between the nodes, so as to access node status data and node management functions,

a graphical user interface being adapted to cooperate with the manager for graphically displaying

representations of nodes of the group of nodes from node status data,

representations of node management functions, said manager being also capable of responding to a user action on a representation of said node management function, for causing execution of that node management function.

In another aspect, this invention concerns a method to manage nodes of a group of nodes having node management functions, said method comprising the steps of:

a. displaying representations of nodes of the group of nodes and representations of node management functions,

a1. updating some representations while accessing node status data,

b. responsive to a user action on a representation of node management function,

b1. causing the execution of said node management function.

Other alternative features and advantages of the invention will appear in the detailed description below and in the appended drawings.

### BRIEF DESCRIPTION OF THE FIGURES

FIG. 1 is a general diagram of a distributed computer system comprising a diskfull node and a diskless node.

FIG. 2 is a general diagram of a distributed computer system having control facilities according to an embodiment of the invention.

FIG. 3 is a functional diagram of a node using a network protocol according to an embodiment of the invention.

FIG. 4 is an embodiment of the logical architecture of an embodiment of the invention.

FIG. 5 is an example of a general window using of a graphical user interface view according to an embodiment of the invention.

FIG. 6A is an example of a first window activated from the general window of FIG. 5.

FIG. 6B is an example of a node menu activated from the general window of FIG. 5.

FIG. 6B is another example of a node menu activated from the general window of FIG. 5.

FIG. 6C is another example of a node menu activated from the general window of FIG. 5.

FIG. 6D is another example of a node menu activated from the general window of FIG. 5.

FIG. 6E is another example of a node menu activated from the general window of FIG. 5.

FIG. 6F is an example of a general menu activated from the general window of FIG. 5.

FIG. 6G is another example of a general menu activated from the general window of FIG. 5.

FIG. 6H is another example of a general menu activated from the general window of FIG. 5.

FIG. 6I is another example of a general menu activated from the general window of FIG. 5.

FIG. 7 is a flow chart of a user action applied on a node according to an embodiment of the invention.

FIG. 8 is an example of a second window activated from a node menu of an embodiment of the invention.

FIG. 9 is an example of a third window activated from a node menu of an embodiment of the invention.

FIG. 10 is an example of a fourth window activated from a general menu of an embodiment of the invention.

FIG. 11 is an example of a fourth window activated from a general menu of an embodiment of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright and/or author's rights whatsoever.

These drawings are placed apart for the purpose of clarifying the detailed description, and of enabling easier reference. It nevertheless forms an integral part of the description of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

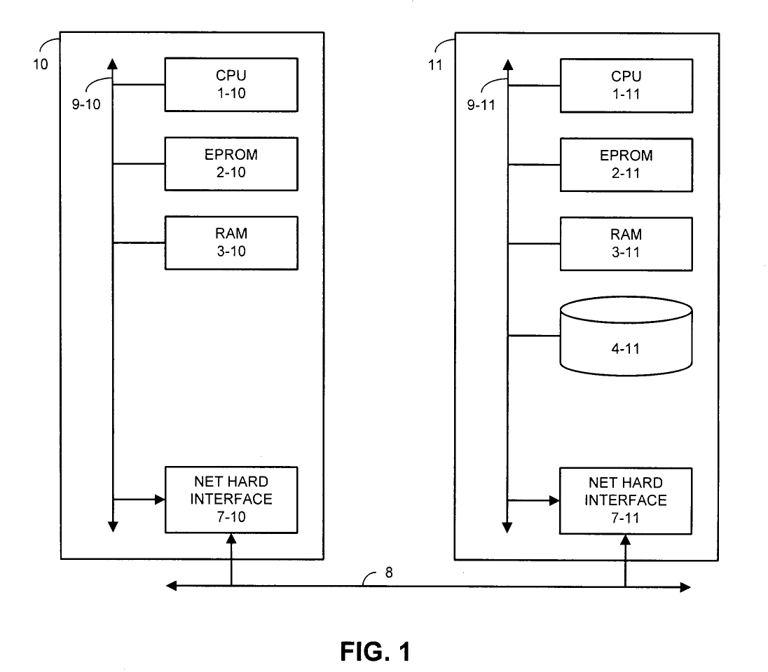

Embodiments of this invention may be implemented in a network comprising computer systems. The hardware of such computer systems is for example as shown in FIG. 1, where in the computer system 10:

1-1O is a processor, e.g. an Ultra-Sparc processor (SPARC is a Trademark of SPARC International Inc);

2-10 is a program memory, e.g. an EPROM for BIOS;

3-10 is a working memory, e.g. a RAM of any suitable technology (SDRAM for example); and

7-10 is a network interface device connected to a communication medium 8, itself in communication with other computers such as computer system 11. Network interface device 7-10 may be an Ethernet device, a serial line device, or an ATM device, inter alia. Medium 8 may be based on wire cables, fiber optics, or radio-communications, for example.

The computer system 10 may be a node amongst a group of nodes in a distributed computer system. The other node 11 comprises the same components as node 10, the components being designated with the suffix 11. The node 11 further comprises a mass memory 4-11, e.g. one or more hard disks.

Thus, node 10 is considered as a diskless node and node 11 is considered as a diskfull node.

Data may be exchanged between the components of FIG. 1 through a bus system 9-10, respectively 9-11, schematically shown as a single bus for simplification of the drawing. As is known, bus systems may often include a processor bus, e.g. of the PCI type, connected via appropriate bridges to e.g. an ISA bus and/or an SCSI bus.

FIG. 1 depicts two connected nodes.

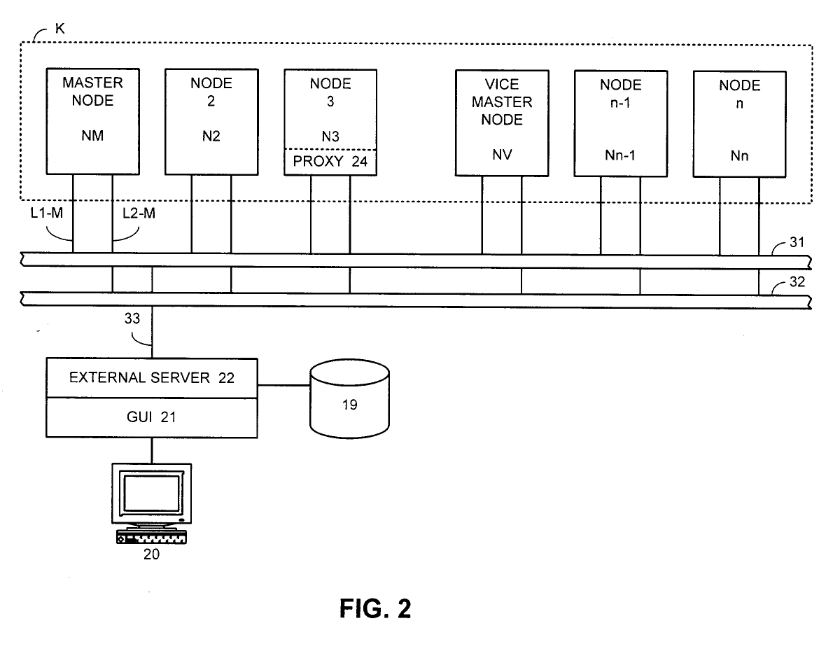

FIG. 2 represents an example of physical realization of an embodiment of the invention. In particular, it shows an example of a group of nodes arranged as a cluster K. The cluster has a master node NM, a vice-master node NV and other nodes N2, N3 . . . Nn−1 and Nn. The qualification as master or as vice-master should be viewed as dynamic: one of the nodes acts as the master (resp. Vice-master) at a given time. However, for being eligible as a master or vice-master (nodes which are called master eligible nodes), a node needs to have the required “master” functionality. A node being diskfull is considered to have at least partially this master functionality.

References to the drawings in the following description will use two different indexes or suffixes i and j, each of which may take any of the values: {M, V, 2. . . n}, n+1 being the number of nodes in the cluster.

In FIG. 2, each node Ni of cluster K is connected to a first network 31 via links L1-i. This network 31 is adapted to interconnect this node Ni with another node Nj through the link L1-j. If desired, the Ethernet link is also redundant: each node Ni of cluster K is connected to a second network 32 via links L2-i. This network 32 is adapted to interconnect this node Ni with another node Nj through the link L2j. For example, if node N2 sends a packet to node Nn, the packet is therefore duplicated to be sent on both networks. In fact, the foregoing description assumes that the second network for a node may be used in parallel with the first network. This redundant functionality can be provided by the software platform.

Also, as an example, it is assumed that packets are generally built throughout the network in accordance with a transport protocol and a presentation protocol, e.g. the Ethernet Protocol and the Internet Protocol. Corresponding IP addresses are converted into Ethernet addresses on Ethernet network sections.

In a more detailed exemplary embodiment and according to the Internet Protocol, a packet having an IP header comprises identification data as the source and destination fields, e.g. according to RFC-791. The source and destination fields are the IP address of the sending node and the IP address of the receiving node. It will be seen that a node has several IP addresses, for its various network interfaces. Although other choices are possible, it is assumed that the IP address of a node (in the source or destination field) is the address of its IP interface 100 (to be described).

The embodiment provides an external server 22 connected to the network 31 via a link 33, this external server being a client of the nodes of the cluster. The external server 22 is also connected to the graphical user interface 21. This graphical user interface 21 is connected to a display monitor 20, also called a display screen and to a memory 19. The external server 22 (also called a manager) is adapted to retrieve data concerning node management functions and the graphical user interface is adapted to provide a graphical window representing nodes of the group of nodes and functions related to the nodes. A user may request, through the graphical window, for an execution of a function. On the user request, the external server may send a request which causes the execution of a function of the cluster, i.e. to cause the execution of services in common for the nodes of the cluster (as described hereinafter: reboot service, switch-over service), or to send a request to cause the execution of a function in a node (as described hereinafter: applications in a node). In this last case, the external server 22 sends its request to a proxy module in a node as N3. This proxy module is adapted to work in relation with the other nodes of the cluster. Thus, the proxy module is adapted to request for the execution of the function in the node. The proxy module may be seen as a connection module between the external server and the node.

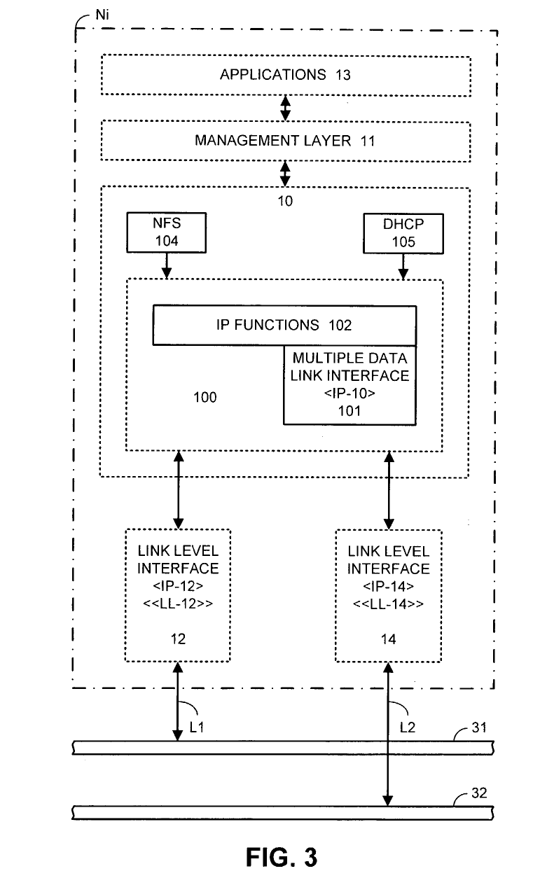

FIG. 3 shows an exemplary node Ni. That node Ni comprises, from top to bottom, applications 13, management layer 11, network protocol stack 10, and Link level interfaces 12 and 14, respectively connected to network links 31 and 32. Node Ni may be part of a local or global network; in the foregoing exemplary description, the network is an Ethernet network, by way of example only. It is assumed that each node may be uniquely defined by a portion of its Ethernet address. Accordingly, as used hereinafter, “IP address” means an address uniquely designating a node in the network being considered (e.g. a cluster), whichever network protocol is being used. Although Ethernet is presently convenient, no restriction to Ethernet is intended.

Thus, in the example, network protocol stack 10 comprises:

an IP interface 100, having conventional Internet protocol (IP) functions 102, and a multiple data link interface 101,

above IP interface 100, message protocol processing functions, e.g. a NFS function 104 (Network File System) adapted to share files between diskfull nodes for example and/or a DHCP function 105. This DHCP function is adapted to use the DHCP protocol as described in the RFC 2131, March 1997, especially for a node boot or reboot.

Network protocol stack 10 is interconnected with the physical networks through first and second Link level interfaces 12 and 14, respectively. These are in turn connected to first and second network channels 31 and 32, via couplings L1 and L2, respectively, more specifically L1-i and L2-i for the exemplary node Ni. More than two channels may be provided.

Link level interface 12 has an Internet address <IP_12> and a link level address <<LL_12>>. Incidentally, the doubled triangular brackets (<<. . . >>) are used only to distinguish link level addresses from global network addresses. Similarly, Link level interface 14 has an Internet address <IP_14> and a link level address <<LL_14>>. In a specific embodiment, where the physical network is Ethernet-based, interfaces 12 and 14 are Ethernet interfaces, and <<LL_12>> and <<LL_14>> are Ethernet addresses.

IP functions 102 comprise encapsulating a message coming from upper layers 104 or 105 into a suitable IP packet format, and, conversely, de-encapsulating a received packet before delivering the message it contains to upper layer 104 or 105.

In redundant operation, the interconnection between IP layer 102 and Link level interfaces 12 and 14 occurs through multiple data link interface 101. The multiple data link interface 101 also has an IP address <IP_10>, which is the node address in a packet sent from source node Ni.

References to Ethernet are exemplary, and other protocols may be used as well, both in stack 10, including multiple data link interface 101, and/or in Link level interfaces 12 and 14.

Furthermore, where no redundancy is required, IP layer 102 may directly exchange messages with anyone of interfaces 12,14, thus by-passing multiple data link interface 101.

It will be appreciated that layers 10 and 11 comprise components to provide a highly available link with application layer 13 running on the node. In each node, the management layer 11 also comprises a management and monitor entity, e.g. a Cluster Membership Monitor (CMM).

In a cluster, several services are provided as known: node functions internal to nodes and cluster functions internal to the master eligible nodes (particularly diskfull nodes). Both may be comprised in functions called node management functions. These functions are at operating system level of nodes. The following services of the cluster are cited for example only and do not represent an exhaustive list of test services:

node function: the management component of each node detects the status of the node,

cluster function 1: the management component of the master node provides a list of nodes in the cluster, the list may indicate the status of each node,

cluster function 2: a node boot service of the master node manages the boot of nodes of the cluster in managing the addresses attribution for example,

cluster function 3: a switch-over service enables the user to replace for a moment the master node with the vice-master node.

Concerning the node function, a node has a status which may be an up status or a down status. Thus, a node may be detected as up or down by its management component.

Concerning the cluster function 2, the node boot service is based on a DHCP server in the master eligible nodes adapted to execute a software program, e.g. the Open Boot Prom of the Sun hardware platform. This node boot service waits for a boot request from a node which sends a “DHCP_DISCOVER” message. After reception of this message, the node boot service sends back data useful to boot the node, thus providing the node address, a boot software program to download on the node, etc.

Concerning the cluster function 3, for high availability reasons, a switch-over may be provided by the software platform e.g. by the Sun platform. A switch-over is a user action provoking the change of the vice-master node into the master node. This enables a change of a software version for example. Thus, the vice master node becomes master node during the switch-over of the master node.

In general, all these functions (and other) manage the nodes of the cluster. In fact, a user may have an access to these functions through the console of each node. It permits a user to establish a connection with successive nodes, to execute a series of instructions using these functions on each node, to retrieve results of said instructions and to exploit said results.

Not only this work is fastidious but it also implies that the user establishes a connection between each node at different times. Thus, the nodes of the cluster cannot be continuously controlled. In particular, the nodes can not be managed at a given moment, e.g. a and the state of the nodes of a cluster.

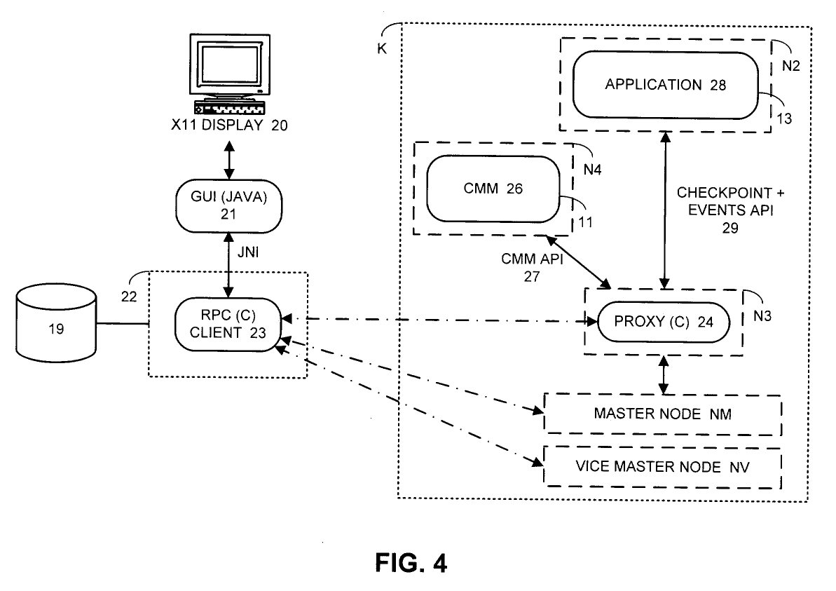

FIG. 4 provides a logical architecture of an embodiment of the invention. For simplification of the FIG. 4, the cluster K comprises nodes in which are represented none or some of the modules of FIG. 3 for a node, although each node comprises the modules of FIG. 3.

The node N3 comprises the proxy 24 adapted to work in relation with the management layer 11 of each node of the cluster, said management layer 26 comprising the management component, e.g. the Cluster Management Membership (CMM) 26. Thus, the proxy 24 requests for the management layer API 27 (e.g. CMM API) to retrieve information from this management component 26. In FIG. 4, the proxy is in relation with the management component 26 of node N4 for example.

According to the invention, the external server 22 provides an application and may create a process for this application in this embodiment on a node of the cluster. This process enables the application to be executed on the node. This application is a real application but is provided by the external server to test checkpoints and events at the application level. A first process for this application may be created on a node N2 and a second process for this application, not shown and being a redundant process of the first process, on another node of the cluster.

Events are messages shared between processes enabling the processes to signal occurrences that may affect the services (errors, fail-over of services, addition of new devices, etc). Such received events enable the processes to ensure the service to be provided without interruptions. In order to share information between processes, Cluster Event Services API (CES API) provides a set of functions to publish an event, to receive an event, to handle received events, etc.

As known, to enable the state of a process to be re-created in case of failure of the process, the process records its state information in a created checkpoint. A checkpoint is a logical entity identified by its name. The checkpoint may provide a checkpoint value corresponding to the number of events received by the process in a node. The checkpoint is created in an area that survives the termination of the process. If the process failed and this process is restarted, the checkpoint is read by this restarted process to retrieve the last state of the process. If the process failed and the redundant process on another node becomes active, the new active process reads the checkpoint to retrieve the state of the last active process. To re-create the state of a process, use the Cluster Replicated Checkpoint Service (CRCS) API which provides functions to create a checkpoint, open a checkpoint, close a checkpoint, remove the name of a checkpoint from a cluster, get information about a checkpoint, write data to a checkpoint, read data from a checkpoint, reset a checkpoint, etc.

As the process is redundant, when the first process is active, the second redundant process is passive. An active process means it can reply to a proxy request. A passive process means it can not reply to a proxy request as the other process is active. The active process is called “primary”, the passive process is called “secondary”. When the primary process fails, the “secondary” process may become “primary”. Both these processes are advantageously created on non master eligible nodes of the cluster. These processes may also be on master eligible nodes. Thus, the proxy is adapted to work in relation with the processes of application 28 running on a node. Other processes on other nodes may be created.

The software platform may enable a primary failed process in a first node to restart on the same node or to restart in a secondary process in a second node if the first node has failed for example. The primary process writes, read and send checkpoints. The secondary process reads these checkpoints. It provides redundancy and high availability in case of primary process failure. In an embodiment of the invention, this process and its redundant process are created on request of the external server enabling for example process functioning test by using checkpoints and events. The proxy 24 requests for the API 29 being Cluster Event Services API (CES API) and Cluster Replicated Checkpoints Services API (CRCS API). These API enable the proxy to send a chosen number of events on an active process and to read new checkpoint value on this process in order to check the state of a process at a given time.

The proxy 24 is adapted to work in relation with the management component 26 and the application level 13 of nodes for internal functions of a node (changing a checkpoint in a process for example, requesting the management component of the node status, etc).

User actions on the screen are directed to the graphical user interface. If these user actions request an internal node function to be executed, the external server may send requests to the proxy. Else, the external server may request directly for the cluster functions in the master eligible nodes for example (node boot service, etc).

The communication between, on one hand, the external server and, on the other hand, the master node, the vice-master node and the proxy may be done via a RPC (Remote procedure call) client 23 on the external server 22. This RPC client 23 enables a RPC communication of cluster data, being in fact request or node data corresponding to action results. The RPC client 23 is connected to the graphical user interface 21 working which may be implemented, for example, in the java programming technology. The communication between the RPC client 23 of the external server 22 and the GUI 21 is enabled by the Java Native Interface (JNI). Indeed, the Java Native Interface (JNI) may be used as a bridge between the Java and C (or C++) languages. More explanations about the JNI may be found at the internet reference http://Java.sun.com/docs/books/tutorial/native 1.1/index.html or the corresponding documentation.

The external server and the proxy may represent a management graphical system providing a graphical view of the state of the cluster (state of nodes, state of services. . . ) on a display monitor. A user may have access at least to representation of node management functions and to representation of node management function results.

The proxy 24 is further adapted to log errors in log file on its diskless node. Generally, node management function results may be stored in a file with an indication of time, for example for node reboot results.

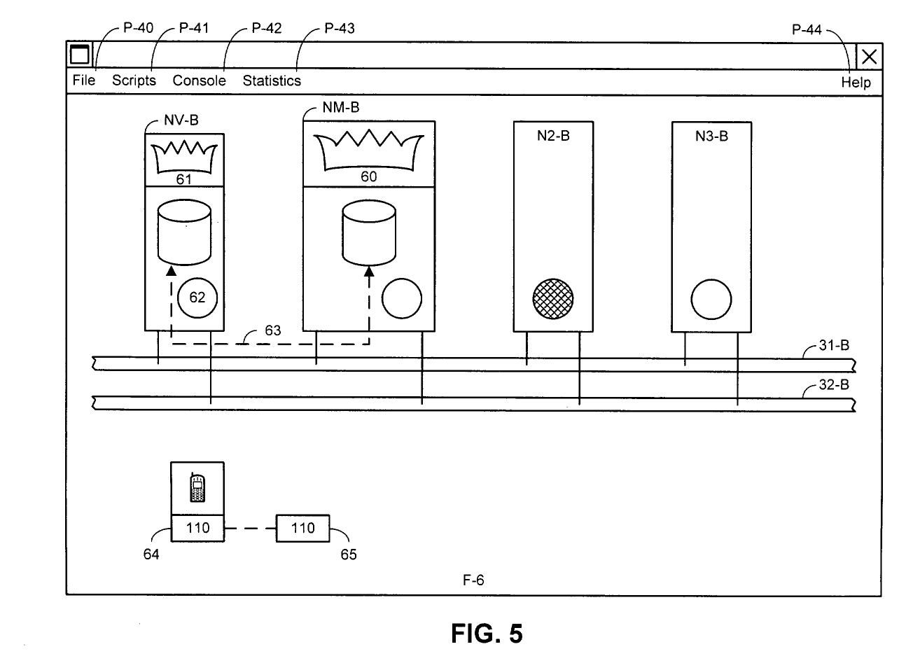

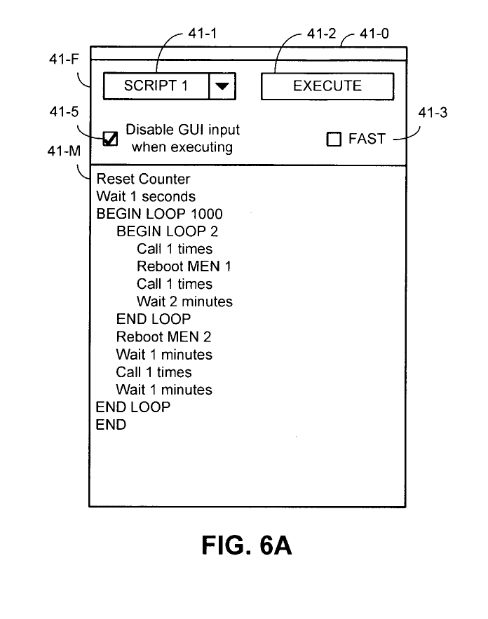

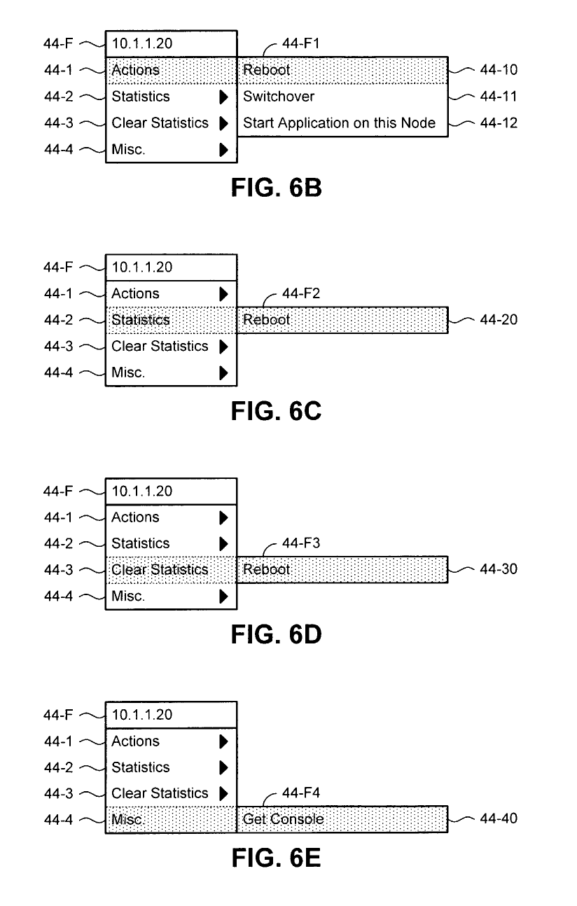

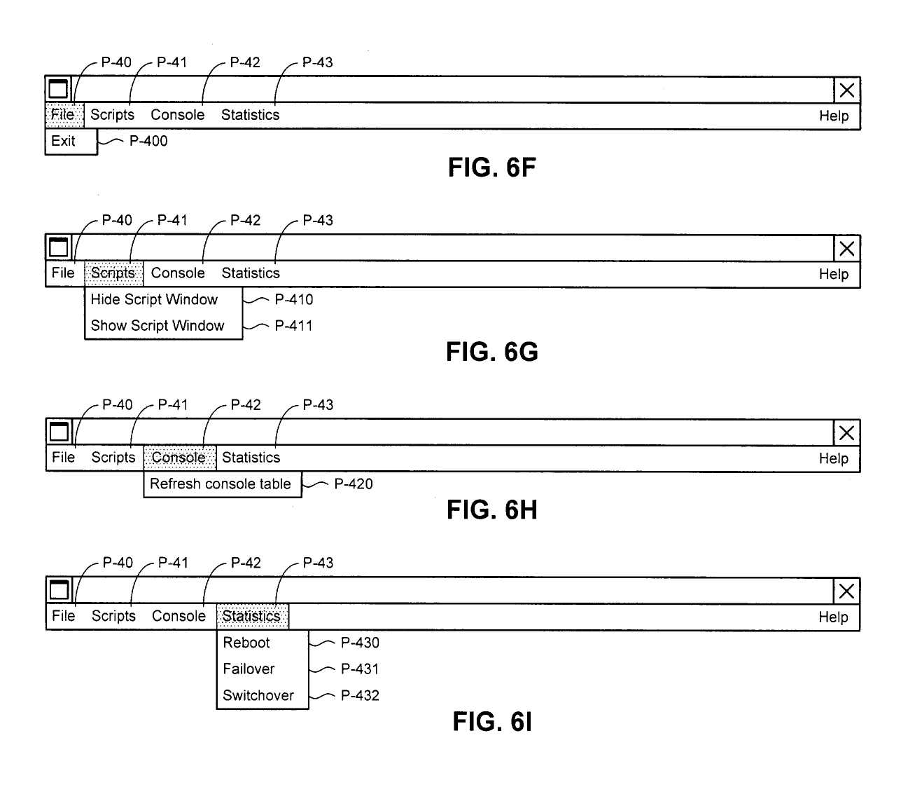

The graphical user interface 21 is adapted to represent representation of node management functions and representation of statistical functions on the display monitor 20 as hereinafter described in FIGS. 5 and 6A to 6I.

FIG. 5 shows an example of a graphical window F-6 on the display screen presenting representation of the whole cluster with representations of nodes NV-B, NM-B, N2-B, N3-B of the cluster and representations of connections between nodes, the redundant links 31-B and 32-B. Thus, in the example, nodes are schematized as node boxes. At least the management layer of the master node has e.g. a list of nodes being in the cluster. The proxy may request the management layer of the master node for this list of nodes in order to represent the nodes in the cluster and to indicate their current address. The proxy may request the management layer, e.g. regularly, to dynamically update the representation of nodes according to these node data being also called node status data. In the embodiment of the invention, master and vice-master nodes are distinguished from other nodes by a representation of a big crown 60 and a small crown 61. The proxy may request the management layer of master node to retrieve the master node and vice master node addresses, being also node status data. A double arrow 63 displayed in for example, green or red, symbolizes respectively a good o bad synchronization between the master and the vice-master node of the cluster according to time criteria. The good or bad synchronization may be indicated when a switch-over is requested for example. The node boxes may also comprised a colored circle 62 which may be displayed in different colors to indicate the status of the node: for example, if the node is up, the circle in the node box may be displayed in green or red, if the node is down, the circle in the node box may be displayed in red. In the example of the FIG. 5, the circle is white for an up node and dark for a down node as N2-B. The circle in a representation of a node being a representation of a node status data enabling to retrieve the node status. The proxy may request the management layer of the master node for the list of nodes indicating the status of nodes. The proxy may also request the management layers of each node which may transmit the status of the node.

For all this information, the proxy reads and sends the node data to the external server 22. The status of nodes indicated by each node and the status of nodes indicated by the list may be compared. Comparing these action results makes it possible to check if the management component functions correctly. To function, the proxy may use e.g. the CMM APT of the management component. Proxy may retrieve regularly node data such as node status, list of nodes in the cluster, etc.

Thus, at the bottom of the screen, a small window 64 indicates the checkpoint value of the current primary process in the cluster. An icon (here shown as a representation of a phone) provides the user a possibility to change the checkpoint value in the small window 64. The user may click on this representation to increase this value with a chosen number of events. Thus, the user requests the external server to send this number of events to the primary process. The external server requests the proxy to send the number of events to the corresponding node. The CES API enables the proxy to send these events. The process receives this new events and, in normal functioning, changes its checkpoint value according to this chosen number of received events. The proxy may read the new checkpoint value on this process and sends this value to the external server modified or not whether events, checkpoints or processes function correctly or not. The proxy then sends back the checkpoint value to the display monitor and the checkpoint value is displayed in the other small window 65. The comparison between both small windows 64 and 65 enables the user to check the functioning of processes, particularly if checkpoints and events are communicated correctly.

In an embodiment of the invention, this graphical window of FIG. 5 may also provide pop-up menus on each node providing representation of node management functions and statistical function. A user, activating one of these representations, requests for an execution of the corresponding node management function or for the corresponding statistical function.

In an embodiment of the invention, when clicking on each node box, a pop-up menu 44-F with a functionality menu appears on the graphical window F-6 as depicted in FIGS. 6B to 6E. For example, when clicking on node representation N2-B having the address 10.1.1.20 in window F-6, the pop-up menu 44-F of FIGS. 6B to 6E appears.

In the pop-up menu 44-F, each line of the menu enables a user to have access to a subpop-up menu and to select a line corresponding to a specific action on the node. In the example of FIGS. 6B to 6E, the pop-up menu 44-F comprises the following lines:

“actions” line 44-1 enabling access to the user to the sub-pop-up menu 44-F1 comprising the following lines corresponding to some node management functions:

“reboot” line 44-10 enabling the user to request for the reboot of the node,

“switch-over” line 44-11 which can be activated if the node is the master node, enabling the user to request for an execution of the switch-over service for the master node,

“start application on this node” line 44-12 enabling the user to request to launch a primary process on the node,

“statistics” line 44-2 enabling access to the user to the sub-pop-up menu 44-F2 comprising the following lines corresponding to statistical functions applied to some node management function results:

“reboot” line 44-20 enabling the user to request for statistics performed on node reboot results (e.g. from line 44-10),

“clear statistics” line 44-3 enabling access to the user to the sub-pop-up menu 44-F3 comprising the following lines

“reboot” line 44-30 enabling the user to request for clear statistics performed on node reboot results,

“Misc” line 44-4 enabling access to the user to the sub-pop-up menu 44-F4 comprising the following line

“Get console” line 44-40 enabling the user to request for the access of the command lines executed on the node.

In an embodiment of the invention, the “reboot” lines 44-10, 44-20 and 44-30 may not be provided for a node having the proxy. Indeed, the proxy provides the external server to have access to some nodes and specifically to some node management functions (such as to have access to the node states).

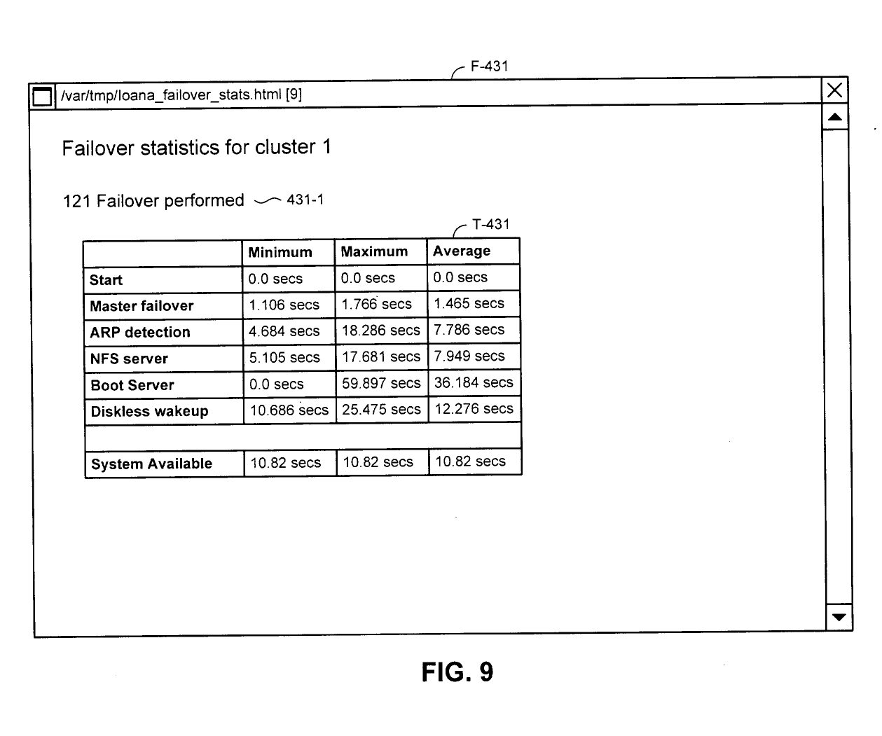

When a user activates the representation of the reboot function for a node (e.g. the “reboot” line 44-10), the graphical user interface sends a boot request (“DHCP_discover” message) via the external server, for example. On reception of this message, the node boot service replies in providing the data useful to boot via the external server. If this node boot service does not reply, the graphical user interface may notify the user that the node boot service did not reply. A problem may be visually detected by the user on the display screen 20. The reboot results are storing with a time indication to inform the required time to reboot the node. For the master node, reboot results may provide the different time indications of the different phases of a fail-over for the master node as described in FIG. 9 for statistics applied to fail-over results.

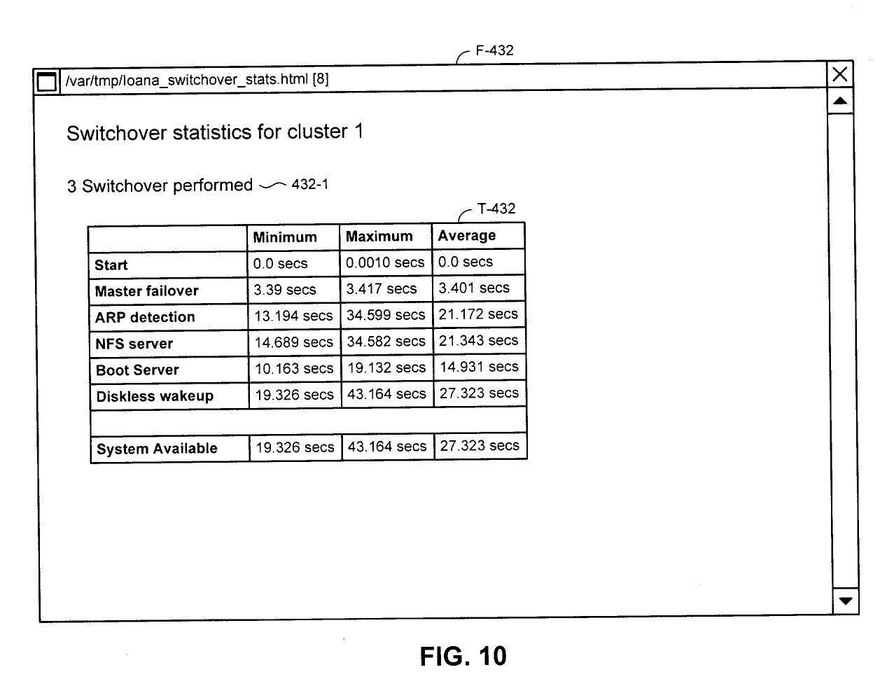

Through the graphical user interface and via the external server, a user may activate the representation of the switch-over function for the master node (e.g. the “switch-over” line 44-11) which causes the execution of the switch-over function for the master node. The action results may be displayed on the display screen nearly in real time. Switch-over results may provide the different time indications of the different phases of a switch-over for the master node as described in FIG. 10 for statistics applied to switch-over results.

These results are specifically described in FIG. 9 for the master node fail-over. These fail-over results may be displayed on the display screen by the graphical user interface. The fail-over results may comprise the time when the action is performed.

At the top of the window, a menu bar indicates a file menu P-40, a scripts menu P-41, a console menu P-42, a statistics menu P-43. When a user clicks on these menus with a mouse for example, menus depicted in FIGS. 6F to 6I appear on the window F-6 of FIG. 5.

In FIG. 6F, the file menu provide the possibility to exit the window with the “exit” button P-400. In FIG. 6G, the scripts menu provides the possibility to get a script window with the “show script window” button P-411 to allow automatic actions performed on the cluster nodes as described in FIG. 6A and the possibility to hide the script window with the “hide script window” button P-410. In FIG. 6H, the console menu P-42 provides the possibility to refresh console table with the button “refresh console table” P-420. When a physical address of a node (e.g. MAC address) does not anymore correspond to an IP address of a node (e.g. when a node has failed, has rebooted and has changed its IP address), this representation of node management function enables the external server to change the physical address of a node corresponding to the IP address indicated on the display. In FIG. 6I, the statistics menu P-43 provides the user to request the execution of the following statistics:

with the button “reboot” P-430, requesting for reboot statistics based on the reboot function results for all the nodes of the cluster, separating the statistics based on time indication of diskfull nodes and the statistics based on time indication of diskless nodes,

with the button “fail-over” P-431, requesting for fail-over statistics based on the fail-over results stored for the master node of the cluster,

with the button “switch-over” P-431, requesting for switch-over statistics based on the switch-over results stored for the master node of the cluster.

FIG. 6A represents an example of a script program according to the invention. Thus, the graphical user interface provides a window having test programs in a scripting language to enable:

automatic test programs to be executed on an application, enabling an automation of actions done with the mouse,

long runs,

quick validation of the cluster install.

The script window 41-O provides a main window 41-M and a function window 41-F The main window 41-M corresponds to an area adapted for showing execution test programs. The test program may be executed when request by the user, sequences of test program may be executed in a loop during a given amount of loops, waiting time may also be in program tests, traces files may also be re-initialization. Other functions may be developed in the script window. In the example, the test program is composed of two loops to reboot a first master eligible node (MEN1) and to reboot a second master eligible node (MEN2) in order to check the reboot function. After each action in the test program, the graphical user interface is updated. In the function window 41-F, options are provided to the user:

the user can choose, by clicking on the option button “fast” 43-3, to execute the program faster,

the user can choose, by clicking on the choice area 41-5, to disable GUI input when the test program is executed,

pop-up menu “script 1” 41-1 enabling the user, by clicking on the button 41-1, to display the menu in which the user can select the testing program (script 1, script 2 etc) to be executed on the cluster,

the button “execute” 41-2 enables the user, by clicking on the button 41-2, to launch the execution of the testing program and to transform the button 41-2 into a “stop” button to stop the execution of the testing program.

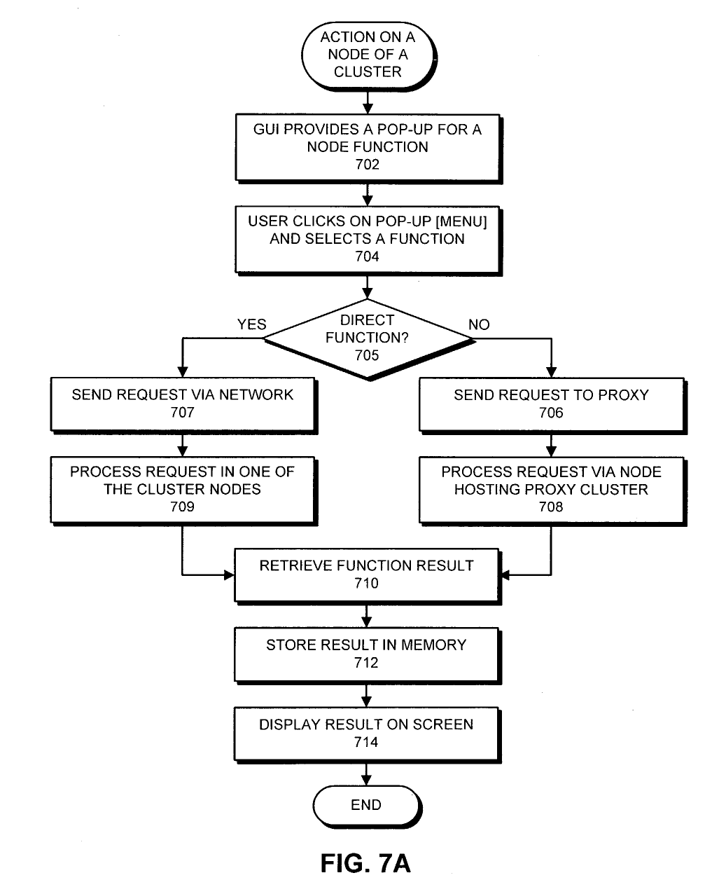

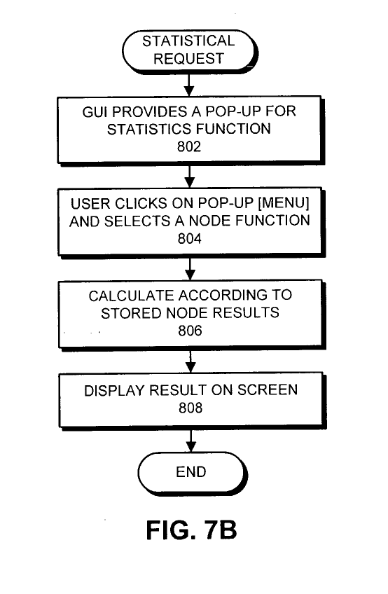

FIG. 7A provides a method for a user to have a direct action on a node of the cluster by requesting an execution of a node management function.

Representation of node management functions or representation of automated test program may be displayed on the screen, e.g. as a pop-up menu, by the graphical user interface (operation 702). When clicking on one of this representation (operation 704), the user selects a representation and requests an execution of the corresponding function on a node of the cluster. Thus, the switch-over of the master node may be requested by the user directly on the screen.

If the function is a direct function on the network (operation 705), e.g. the function is a cluster function as the reboot service in the master eligible node, the external server sends the request via the network (operation 707) and the request is processed in the nodes chosen by the user (operation 709).

If the function is a not a direct function on the network (operation 706), e.g. the function is an internal node function, the external server sends the request to the proxy (operation 706). The proxy causes the execution of the function in the node chosen by the user (operation 708).

In both cases, the proxy retrieves the result of the executed function (operation 710). This result is stored in a memory, e.g. in a file of the external server with a time indication (operation 712) and sends to the external user. The graphical window displays on the screen the result of the function and enables a user to check dynamically the impact of its action on the cluster (operation 114). More specifically, graphical window displays on the screen the node and its action result.

As seen, the graphical user interface may display checkpoint values for an active process. With these stored results, statistics may be requested as described in the method of FIG. 7-B. FIG. 7B provides a method for a user to request for statistical computation.

In operation 802, the external server provides, through the graphical user interface, a pop-up menu for statistics on a node or for statistics on the cluster as depicted in FIGS. 6B to 6I.

In operation 804, a user selects in this pop-up menu a representation of a node management function. At operation 806, statistical computations on results of this node management function are executed in the external server. At operation 808, the result of these computations are displayed on the screen. The method ends but may starts again at operation 802.

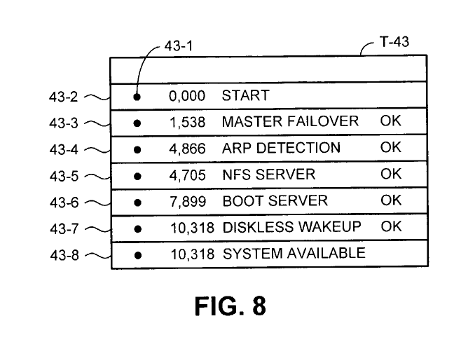

To enable statistical computations, the results of node management functions executed responsive to the user action (or responsive to the request of an entity of the cluster as the management component, master node. . . ) are stored. Moreover, the state of the cluster may be regularly checked by the management graphical system and displayed dynamically on the screen. FIG. 8 illustrates an historic of the actions done for a reboot of the master node, every actions having time indication.

Thus, in FIG. 8, the result window comprises time indications for a fail-over of a master node computed from the time indications of reboot results of the master node. The result window of FIG. 8 comprises the table T-43 having rows indicating the following classed times:

the start time of a fail-over of the master node 43-2,

the delay when the vice-master is elected as master 43-3,

the delay when the ARP (Address Recognize Protocol) detects the new address of the master 43-4,

the delay when the NFS (Network File System) server is ready again to give service to the cluster nodes 43-5,

the delay when the boot server is ready again to give service to the cluster nodes 43-6,

the delay when diskless nodes wake-up 43-7,

the delay when the system is available with the new master and the different services 43-8.

All the time indications (delays) are given dynamically and all the lights 43-1 are red until a change into a green light indicating the action is realized at the written delay (or time).

The reboot may have been requested by the user with the execution of the line 44-10 in FIG. 6B.

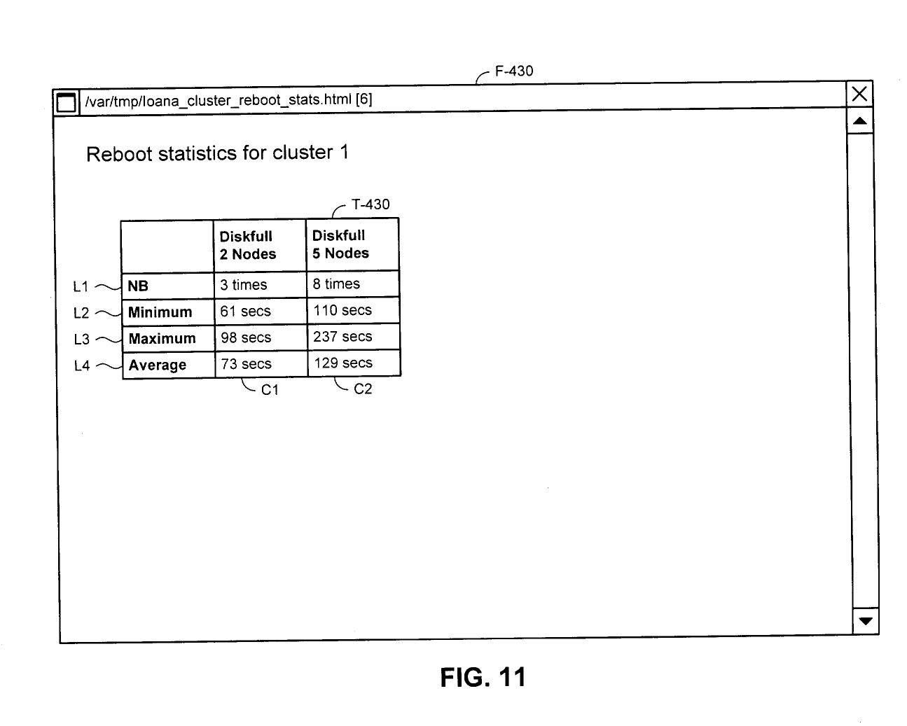

As results of functions are stored in memory (e.g. in disk in the external server), statistics may be performed on these results. FIGS. 9, 10 and 11 illustrate statistics concerning respectively fail-over of the master node (line P-431 in FIG. 6I), switch-over of the master node (line P-432 in FIG. 6I) and reboot of the nodes of the cluster (line P-430 in FIG. 6I). Indeed, these time indications and counts are available in a memory, the user may choose a window providing statistical results.

In FIG. 9, the statistical window F-431 indicates the number of fail-over of the node (121 fail-over performed as indicated in 431-1). These fail-over data may be stored in the memory 19 of FIG. 4. In fact, in this example, the fail-over data are only retrieved from reboots of the master node requested by the user through the graphical interface. The statistical window F-431 indicates in a table T-431 the same type of information as in the table T-43 of FIG. 8.

Each of the delay value is calculated to obtained in three different columns of the table a minimum value of delay (min), a maximum value of delay (max) and an average value of delay (avrg).

As in FIG. 9, FIG. 10 represents a statistical window F-432 indicating the number of switch-over performed on the master node (3 switch-over performed as indicated in 432-1). These switch-over data may be stored in the memory 19 of FIG. 4. The statistical window F-432 indicates in a table T-432 the same type of information as in the table T-43 of FIG. 9 with the same three columns (minimum, maximum, average).

As in FIGS. 9 and 10, FIG. 11 represents a statistical window F-430 indicating in a table T-430 the reboot statistic results for diskfull nodes in column C1 and for diskless nodes in column C2. The reboot data may be stored in the memory 19 of FIG. 4 to enable the external server to compute the statistical results indicated in this table T-430. In line L1 of the table is indicated separately the number of reboots performed on the diskfull nodes (3 times) and the number of reboots performed on diskless nodes (8 times). In line L2, L3, L4, the minimum, maximum and average delay value after which the node has reboot is indicated separately for the diskfull nodes and for the diskless nodes.

These statistical functions provided by the external server based on node management function results stored in a memory enable the user to have a general view of the cluster.

The invention enables a user to have quick cluster validation tools, statistical results concerning the cluster. Moreover, it enables a user to have a whole view on nodes of the cluster and a graphical state of the cluster.

The invention is not limited to the hereinabove examples. Thus, other node management functions may be added according to the invention. For example, after a fail-over of a master node, the time for a file system to be replicated and to be synchronized may be measured, retrieved by the proxy requesting the management layer. Statistics may be applied on these replicated file system time results. Other node management functions may be tested and the corresponding statistics may be computed. Then, it can be developed to enable the user to retrieve a display of more complete statistics. The configuration of the cluster and the detection of the cluster may be automatic.

The node boot service may be tested automatically e.g. in checking regularly if this node boot service is active or passive.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer system for use in relation with a group of nodes, comprising:
a manager adapted for communication with a link to a network existing between the nodes, so as to access node status data and node management functions,
a graphical user interface being adapted to cooperate with the manager for graphically displaying
representations of nodes of the group of nodes from node status data,
representations of node management functions, said manager being also capable of responding to a user action on a representation of said node management function, for causing execution of that node management function.

2. The computer system of claim 1, wherein the manager is adapted to retrieve the node management function result after the execution of said node management function for at least a node of the group of nodes.

3. The computer system as claimed in any of the preceding claims, wherein the graphical user interface is adapted to display graphically and dynamically representations of results of node management functions.

4. The computer system of claim 3, wherein the manager is further adapted to store the result of a node management function, said result of a node management function comprising a time indication.

5. The computer system of claim 4, wherein the manager comprises a statistical function adapted to calculate statistics based on stored results of node management functions and the graphical user interface is adapted to display representations of statistical functions for a node and for the group of nodes, said statistical functions being adapted to be executed by the manager responsive to a user action on their representations.

6. The computer system of claim 5, wherein said statistic functions comprise calculating the minimum value, the maximum value and the average value of the stored results of node management functions.

7. The computer system of claim 1, wherein the manager is adapted to cause the execution of a first node management function for use to reboot a node responsive to a user action on the representation of said first node management function and the manager is adapted to retrieve the time indications concerning said reboot.

8. The computer system of claim 1, wherein the manager is adapted to cause the execution of a second node management function for use to manage a switch-over of a master eligible node, responsive to a user action on the representation of said second node management function and the manager is adapted to retrieve the time indications concerning said switch-over.

9. The computer system of claim 1, wherein the node status data comprises the status of a node requested to a management component of the node.

10. The computer system of claim 1, wherein the manager is adapted to provide at least an application and to cause the execution of a third node management function for use to create a process for this application in a node responsive to a user action on the representation of said third node management function.

11. The computer system of claim 1, wherein the manager is adapted to cause the execution of a fourth management function for use to manage a value change of a checkpoint in a process, responsive to a user action on the representation of said fourth management function and the manager is adapted to retrieve the value change.

12. The computer system of claim 1, wherein the manager is adapted to provide scripting language used to automate test programs.

13. A method to manage nodes of a group of nodes having node management functions, said method comprising the steps of:
a. displaying representations of nodes of the group of nodes and representations of node management functions,
a1. updating some representations while accessing node status data,
b responsive to a user action on a representation of node management function,
b1. causing the execution of said node management function.

14. The method of claim 13, wherein step b. further comprises the following step b2. retrieving the node management function result after the execution of said node management function for at least a node of the group of nodes.

15. The method of claim 14, wherein step b. further comprises the following step b3. displaying graphically and dynamically representations of results of node management functions.

16. The method of claim 15, wherein step b2. comprises storing the result of a node management function in the memory, said result of a node management function comprising a time indication.

17. The method of claim 13, wherein step a. comprises providing statistical functions, step b1. further comprises causing the execution of said statistical function for a node or for the group of nodes, step b2. comprises calculating statistics based on stored results of node management functions.

18. The method of claim 17, wherein step b2. comprises calculating the minimum value, the maximum value and the average value of the stored results of node management functions.

19. The method of claim 13, wherein step b1. comprises causing the execution of a first node management function for use to reboot a node and step b2. comprises retrieving the time indications concerning said reboot.

20. The method of claim 13, wherein step b1. comprises causing the execution of a second node management function for use to manage a switch-over of a master eligible node and step b2. comprises retrieving the time indications concerning said switch-over.

21. The method of claim 13, wherein node status data of step a1. comprises the status of a node requested to a management component of the node.

22. The method of claim 13, wherein step a. comprises providing at least an application and step b1. comprises causing the execution of a third node management function for use to create a process for an application in a node.

23. The method of claim 13, wherein step b1. comprises causing the execution of a fourth management function for use to manage a value change of a checkpoint in a process and step b2. comprises retrieving the value change.

24. The method of claim 13, wherein step a. comprises providing scripting language used to automate test programs.

25. A computer-readable storage medium storing instructions that when executed by a computer cause the computer to perform a method to manage nodes of a group of nodes having node management functions, said method comprising the steps of:
a. displaying representations of nodes of the group of nodes and representations of node management functions,
a1. updating some representations while accessing node status data,
b. responsive to a user action on a representation of node management function,
b1. causing the execution of said node management function.
